(19) United States
(12) Patent Application Publication
(10) Pub. No.: US 2009/0306968 A1
(43) Pub. Date: Dec. 10, 2009

(54) SYSTEM AND METHOD OF GRANTING IDENTIFICATION CODES TO ELECTRONIC TEACHING MATERIAL CONTENTS' SENTENCE STRUCTURES, SYSTEM AND METHOD OF SEARCHING DATA OF ELECTRONIC TEACHING MATERIAL CONTENTS, SYSTEM AND METHOD OF MANAGING POINTS OF USE AND SERVICE OF ELECTRONIC TEACHING MATERIAL CONTENTS

(75) Inventor: Yonghwa Kim, Incheon-shi (KR)

Correspondence Address: HAMRE, SCHUMANN, MUELLER & LARSON, P.C., P.O. BOX 2902, MINNEAPOLIS, MN, 55402-0902, US

(73) Assignees: Yonghwa Kim, Incheon-shi (KR); EGC & C CO., LTD., Seoul (KR)

(21) Appl. No.: 12/539,943

(22) Filed: Aug. 12, 2009

Related U.S. Application Data
(63) Continuation of application No. PCT/KR2008/000724, filed on Feb. 5, 2008.

(30) Foreign Application Priority Data
Feb. 12, 2007 (KR) 10-2007-0014191

(51) Int. Cl. G10L 13/00

(52) U.S. Cl. 704/9; 704/E13.001

(57) ABSTRACT

Disclosed is a system, which grants identification code to sentence structures of electronic teaching material contents, includes the following units. The identification code production unit distinguishes each syllable of electronic teaching material content's selected sentence structure according to type of language, and produces peculiar identification code using the first phoneme or syllable of each syllable. The identification code grant unit grants identification code to metadata of file which stores electronic teaching material contents of above.

### CROSS-REFERENCE TO RELATED APPLICATIONS

This application is a continuation-in-part of international application No. PCT/KR2008/000724, filed Feb. 5, 2008, which claims the benefit of Korean patent application No. 10-2007-0014191 filed Feb. 12, 2007. The disclosures of said applications are incorporated by reference herein.

### FIELD OF THE INVENTION

The present invention is the system and method of granting identification codes to electronic teaching material contents' sentence structures, the system and method of searching data of electronic teaching material contents, the system and method of managing points of the use and service of electronic teaching material contents, especially, by managing electronic teaching material's fundamental contents and important search standards with the identification code system, and managing electronic teaching material's trade process, which makes electronic teaching material search easier and revitalizes the circulation of electronic teaching material.

### BACKGROUND OF THE INVENTION

Due to the fast spread of personal computers and internet, the demand for digital data and multimedia contents has increased tremendously. Video clips, audios, images, text data and other digital data have increased significantly, and, also, the quantity and variety of electronic teaching materials have diversified, enriched and increased.

Meanwhile, along with the increase of internet speed, creating multimedia files and digital text data using multimedia equipments such as digital cameras and portable terminals has become possible, increasing the interest in user-created-contents.

These user-created-contents are very popular due to the sharing of personal information and opinion, and inclusion of entertaining elements. However, because users are creating these contents and data without a standard platform, it is becoming more difficult to systemically manage the increasing number of contents. Additionally, because the contents are scattered, it is difficult to search and use the contents. Moreover, because evaluation on reliability and quality of contents is difficult, it is difficult to guarantee the use of contents to individual users.

The present invention is designed to solve the problems mentioned above. The invention is designed to provide a convenient system and method so that the user can create and register electronic teaching material contents, grant identification codes and manage the immense amount of data according to class, provide reliable information on data to users, and easily search and peruse electronic teaching material contents.

### SUMMARY OF THE INVENTION

The present invention presents a system that classifies syllables in a selected sentence structure according to their respective languages and grants identification codes to electronic teaching material contents. The system is divided into the identification code production part, which produces peculiar identification codes using the first phoneme or syllable of each syllable, and the identification code grant part, which grants identification codes to metadata of the file, which contains the electronic teaching material contents above.

Additionally, the present invention presents a method, which is divided into two stages, of granting identification codes to electronic teaching material contents. Stage one is where the identification code production part classifies each syllable according to the type of language for the selected sentences of the electronic material contents and produces peculiar identification codes using the first phoneme or syllable of each syllable. Stage two is where the identification code grant part grants identification codes to metadata of the file that contains the electronic teaching material contents above.

Additionally, the present invention presents a data search system of electronic teaching material contents which includes the following parts. The identification code extraction part, which receives requests from the user's terminal for electronic teaching material content data that has peculiar identification codes, and extracts the corresponding identification codes; the data request part, which transmits to the web server the identification codes corresponding to the electronic teaching material contents extracted from the identification code extraction part, and requests the electronic teaching material content data that matches the identification code above; The data transmission part, which receives the electronic teaching material content data that was requested by the data request part above to the web server and transmits it to the user's terminal.

Additionally, the present invention presents an electronic teaching material content data search system which includes the following stages. Stage one is when the identification code extraction part receives requests for electronic teaching material content data that has peculiar identification codes from user's terminal and extracts the corresponding identification codes. Stage two is when the data request part requests the electronic teaching material content data that matches the identification codes above. Stage three is when the data transmission part receives the electronic teaching material content data that was requested by data request part above to the web server and transmits it to the user's terminal.

Additionally, the present invention presents a point managing system on the usage and service of electronic teaching material contents which includes the following parts. The user information extraction part extracts user's information from the storage part. The contents management part decides whether to use the electronic teaching material contents on the user's terminal or provide it to another user. The transmission part transmits user terminal's number of inquiry and recommendation of electronic teaching material contents upon service of electronic teaching material contents to the storage part. The point management part decides the level of electronic teaching material based on the above number of inquiry and recommendation, and grants or deducts points on the user's terminal that has provided the electronic teaching material above based on the corresponding teaching material's usage or provision.

Additionally, the present invention presents a point managing system on the usage and provision of electronic teaching material contents which includes the following stages. Stage one is when the user information extraction part extracts user's information from the storage part. Stage two is when the contents management part decides whether to use the electronic teaching material contents on the user's terminal or provide it to another user. Stage three is when the transmission part transmits user terminal's number of inquiry and recommendation of electronic teaching material contents upon service of electronic teaching material contents to the storage part. Stage four is when the point management part decides the level of electronic teaching material based on the above number of inquiry and recommendation, and grants or deducts points on the user's terminal that has provided the electronic teaching material above based on the corresponding teaching material's usage or provision.

The present invention has the following effects. First, individual users can easily create and register a wide variety of electronic teaching material contents. Also, it increases the speed of search and convenience of usage by providing search related information on the electronic teaching material contents based on their identification codes.

Second, by granting identification codes to the electronic teaching material contents that is to be registered, systematically managing the immense amount of contents according to their respective levels is possible.

Third, with the identification code system as basis, by operating policies regarding the production, circulation, consumption of contents and trade of points (mileage), incentives regarding profit produced during the circulation stage can be returned to the users, thus encouraging them to register electronic teaching material contents. Additionally, electronic teaching material contents can be effectively collected, increasing the size of the system. Moreover, by granting incentives to high-quality contents and exemplary users, the increase in quality level of contents can be sought.

Fourth, reliable information on the contents is provided to the users based on the information regarding level of electronic teaching materials and users decided during the circulation stage of electronic teaching materials. This information is stored and become increasingly reliable as users repeatedly use the contents based on number of inquiry and recommendation.

### BRIEF DESCRIPTION OF THE DRAWINGS

FIG. 1 is a composition diagram of the system which grants identification codes to sentence structures of electronic teaching material contents, according to the present invention.

FIG. 2 through FIG. 4 is a diagram describing the method of granting identification codes to electronic teaching material content's sentence structures, according to the present invention.

FIG. 5 is a diagram describing the process of adding identification codes to the metadata of electronic teaching material files, according to the present invention.

FIG. 6 is a diagram of the data search system, according to the present invention.

FIG. 7 is a composition diagram of the point management system regarding usage and provision of electronic teaching material contents, according to the present invention.

FIG. 8 is a diagram describing the action process needed between the user's terminal and system server when using electronic teaching material files, according to the present invention.

FIG. 9 is a table showing the standards for determining levels of registering electronic teaching material contents and users, according to the present invention.

FIG. 10 is a table showing the standards for determining levels of electronic teaching material contents based on the number of inquiry and recommendation of users, according to the present invention.

FIG. 11 is a table showing the standards for giving points for user's individual works, according to the present invention.

FIG. 12 is a table showing the standards for giving points based on levels of electronic teaching materials, according to the present invention.

FIG. 13 is an explanation diagram showing the standards for giving points when a trade occurs internally in an electronic teaching material community, according to the present invention.

FIG. 14 is a flow chart showing the method of granting identification codes to electronic teaching material contents' sentence structures, according to the present invention.

FIG. 15 is a flow chart showing the method of searching data of electronic teaching material contents, according to the present invention.

FIG. 16 is a flow chart showing the method of managing points regarding usage and provision of electronic teaching material contents, according to the present invention.

### DETAILED DESCRIPTION OF THE INVENTION

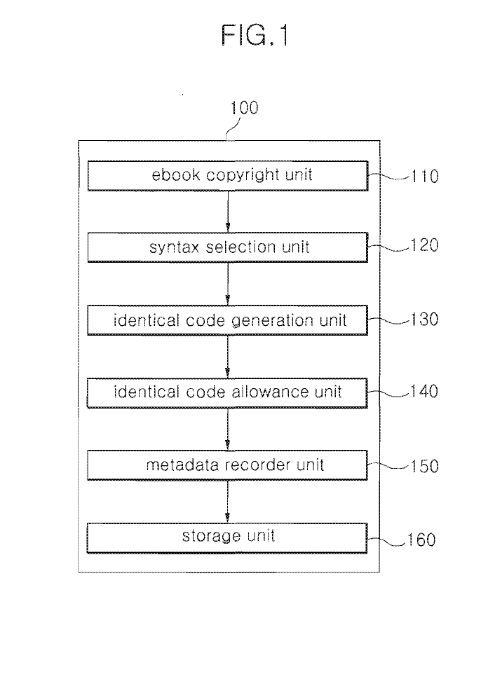

FIG. 1 is a composition diagram of the system which grants identification codes to sentence structures of electronic teaching material contents, according to the present invention. As illustrated in FIG. 1, the system that grants identification codes to sentence structures of electronic teaching material contents (100) is consisted of electronic teaching material creation part (110), sentence structure selection part (120), identification code production part (130), identification code grant part (140), metadata record part (150) and storage part (160).

The electronic teaching material creation part (110) creates electronic teaching materials on the web server using electronic teaching material contents.

The sentence structure selection part (120) selects the sentence structure of electronic teaching materials when created electronic teaching materials are registered on the web server.

The identification code production part (130) produces peculiar identification codes of the selected sentence structures. Thus, identification code production part (130) distinguishes the selected sentence structures of electronic teaching materials into units (phrase or syllable) according to its respective languages, and produces peculiar identification codes using the basic units or each units.

The identification code grant part (140) grants identification codes to metadata of files which store the electronic teaching material contents. Thus, the identification code grant part (140) grants identification codes which are produced from the combination of text data of sentence structures and language information data of the corresponding text data.

The metadata record part (150) records identification codes which are granted to the combination of metadata's text data of electronic teaching material contents file and language information data of the corresponding text data.

The storage part (160) stores electronic teaching material contents file which is recorded on metadata to the database. Thus, it transmits the electronic teaching material file from the electronic teaching material creator's terminal to the system server via web, and stores it in the database.

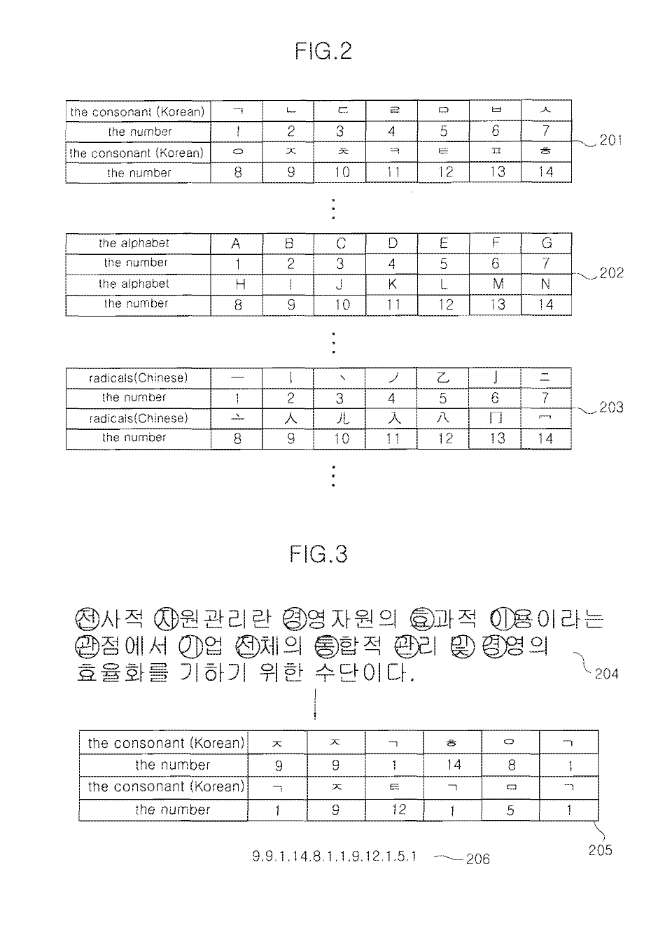

FIG. 2 through FIG. 4 are diagrams showing methods of granting identification codes to sentence structures of electronic teaching material contents, according to the present invention.

In each language, smallest units such as basic phoneme or syllable, alphabet and busu (smallest unit in Chinese characters) exist. These units are referred to as basic units. In Korean, phonemes such as [symbol] [symbol] are considered as basic units. In English, alphabets such as “a b c d e . . . x y z” are considered as basic units. In Chinese, busu such as [symbol] are considered as basic units. Identically as above, other languages determine the smallest unit of their language as their basic unit

Arrange the basic unit of each language in order and assign a number code for each unit in order. Decimal numbers that can be represented in 8 bits are assigned as number codes. For example, as shown in FIG. 2, Korean, which has 24 basic units (phonemes) such as [symbol] [symbol] are assigned decimals 1˜24(201). Likewise, “a b c d e . . . x y z”, the 26 basic units (alphabet) of English are assigned decimals 1˜26(202), and [symbol] [symbol] the 214 basic units (busu) of Chinese are assigned decimals 1˜214(203)

Additionally, break units exist in selected sentence structures. For example, among each unit (spaced words or syllables) consisting a sentence structure, extract the first character or basic unit (phoneme, syllable, alphabet, busu, etc.) of the first 12 units. For example, in FIG. 3, extract the first basic unit (phoneme) of the first 12 units, [symbol] [symbol] [symbol] [symbol] [symbol] of Korean sentence structure [symbol] [symbol] [symbol] [symbol] [symbol] [symbol] [symbol] [symbol] [symbol] [symbol] [symbol] [symbol] (204)

Numbers of each corresponding basic unit of the first 12 units are combined to make a partial identification code of 96 bits (12 bytes). For example, the Korean partial identification code is a combination of “9”, corresponding to [symbol] “9”, corresponding to [symbol] “1”, corresponding [symbol] “14”, corresponding to [symbol] “8”, corresponding to [symbol] “1”, corresponding to [symbol] “1”, corresponding to [symbol] “9”, corresponding to [symbol] “12”, corresponding to [symbol] (rest omitted) (205). In case, units of the sentence (word or syllable) are less than 12, empty spaces are filled with the number “0”. Moreover, by combining the first 12 phonemes, a 96 bit partial identification code, “9.9.1.14.8.1.1.9.12.1.5.1” can be made (206).

Likewise, partial identification codes of English sentence structures are produced by extracting the basic unit (alphabet) of first letter of the first 12 break units (word). For example, from the first 12 break units of sentence structure “A network of people or institutions is a large number of them that have a connection with each other and work together as a system.” basic units “a”, “n”, “o”, “p”, “o”, “i”, “i”, “a”, “l”, “n”, “o”, “t” are extracted. Combining the numbers corresponding to the 12 alphabets, a partial identification code of 96 bits, “1.14.15.16.15.9.9.1.12.124.15.20” is produced.

Likewise, partial identification codes of Chinese sentence structures are produced using the following method. For example, ja [symbol] meaning son, is the busu of first syllable [symbol] of the sentence structure [symbol] [symbol] [symbol] Since ja [symbol] is the 39^{th} busu, number “39” is granted, and since gu [symbol] meaning mouth, of [symbol] is the 30^{th} busu, number “30” is granted (rest omitted), producing a 96 bits 12 number code combination “39.30 . . . 0.0”

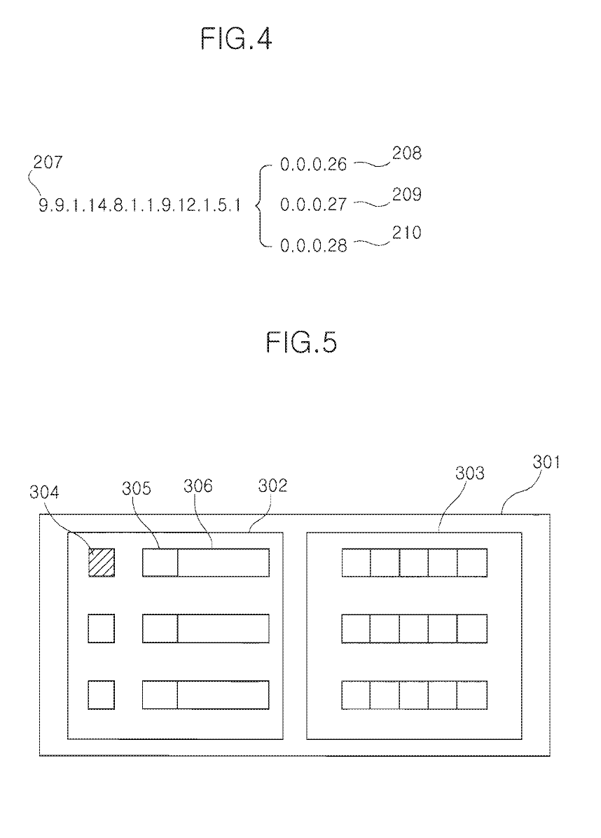

To prevent overlap with pre-existing identification codes, a 34 bit (4 bytes) index is attached to the 96 bit partial identification code produced by the same method as above. The number representing the index is a 8 bit number between 0˜255 on the decimal scale. Also, an index automatically increases by 1 when produced after a pre-existing index. For example, as seen in FIG. 4, when partial identification code “9.9.1.14.8.1.1.9.12.1.5.1” is produced (208), if there are 26 pre-existing indexes, index “0.0.26” is attached to the 27^{th} partial identification code. Likewise, index “0.0.27” is attached to the 28^{th} partial identification code produced since the index automatically increases by 1(209).

The whole identification code is 128 bit (16 bytes), consisted of a 96 bit identification code and a 32 bit index produced using the method above. For example, alike FIG. 3 and FIG. 4, by extracting the 12 basic units from [symbol] [symbol] [symbol] [symbol] [symbol] [symbol] [symbol] [symbol] [symbol] [symbol] [symbol] the partial identification code “9.9.1.14.8.1.1.9.12.1.5.1.” is produced. If there are 26 identification codes produced before, index “0.0.0.26” representing 27^{th} is attached, thus making the sentence's identification code, “9.9.1.14.8.1.1.9.12.1.5.1. 0.0.0.26”

FIG. 5 is a diagram showing the process of adding the identification code of the present invention onto the metadata of electronic teaching material file. As illustrated in FIG. 5, a electronic teaching material file (301) is consisted of the header part (302), which stores information regarding the file, and data part (303), which stores actual data of the file. The header part (302) includes metadata (304˜306), consisted of the combination of text data (306) of selected sentence structures among the contents of electronic teaching materials and language information (305) of corresponding text data, and the identification code (304) granted. More than one data combination of text data (306), language information (305) of corresponding text data and identification code (304) can be recorded inside the metadata of the file's header part.

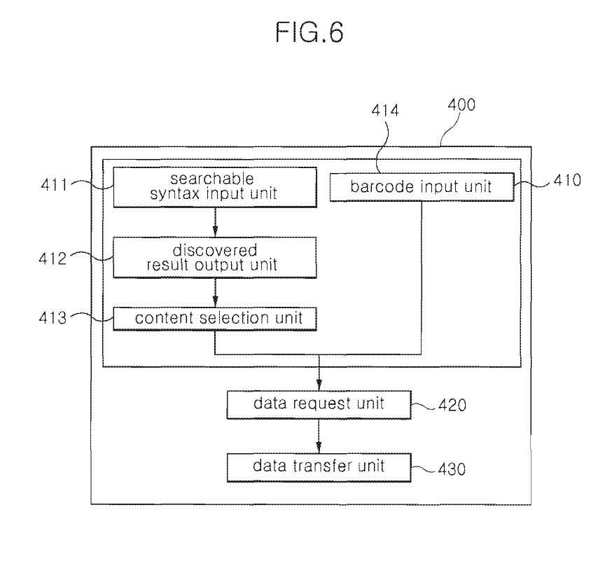

FIG. 6 is a composition diagram of the data search system of electronic teaching material contents of the present invention. As illustrated in FIG. 6, the data search system of electronic teaching material contents (400) includes identification code extraction part (410), data request part (420) and data transmission part (430).

The identification code extraction part (410) receives request for search of electronic teaching material contents data that has peculiar identification codes from the user's terminal, and extracts identification codes corresponding to electronic teaching material contents. Identification code extraction part (410) includes search word sentence structure input part (411), search result output part (412), contents selection part (413) and bar code input part (414). Search word sentence structure input part (411) inputs search word sentence structures and corresponding identification codes when extracting corresponding identification codes from the electronic teaching material contents data above. Search result output part (412) outputs data search results of extracted electronic teaching material contents. Additionally, contents selection part (413) selects corresponding electronic teaching material contents from electronic teaching material contents output. Bar code input part (414) inputs bar code when searching electronic teaching material contents during usage of books.

The data request part (420) transmits corresponding identification codes of electronic teaching material contents data extracted by the identification code extraction part (410) to the web server, and requests data of electronic teaching material contents which matches with the identification code above.

The data transmission part (430) receives electronic teaching material contents data requested by the data request part (420) to the web server, and transmits it to the user's terminal.

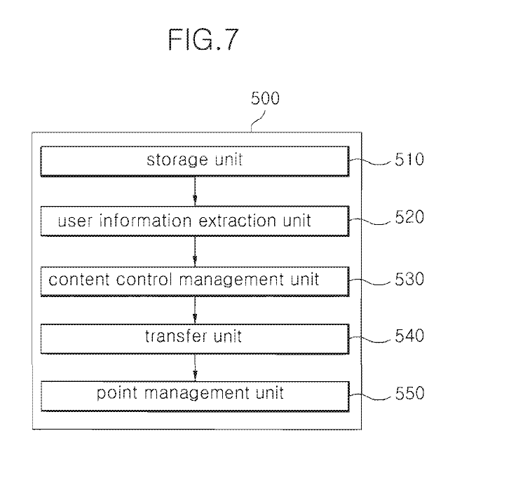

FIG. 7 is a composition diagram of the point management system regarding usage and provision of electronic teaching material contents. As illustrated in FIG. 7, the point management system regarding usage and provision of electronic teaching material contents (500) includes storage part (510), user information extraction part (520), contents management part (530), transmission part (540) and point management part (550).

The storage part (510) stores user information and user terminal's number of inquiry and recommendation regarding electronic teaching material contents data.

The user information extraction part (520) extracts user information from storage part.

The contents management part (530) decides whether to use electronic teaching material contents on user's terminal or provide it to another user's terminal

The transmission part (540) transmits user terminal's number of inquiry and recommendation regarding electronic teaching material contents data to the storage part when providing electronic teaching material contents.

The point management part (550) decides level of electronic teaching materials based on the number of inquiry and recommendation above. Also, it grants or deducts points from the user's terminal that provided the electronic teaching materials above based on the usage or provision of corresponding electronic teaching materials.

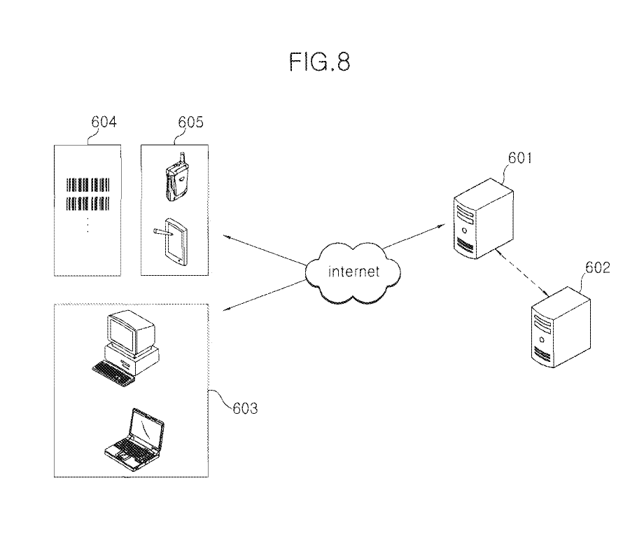

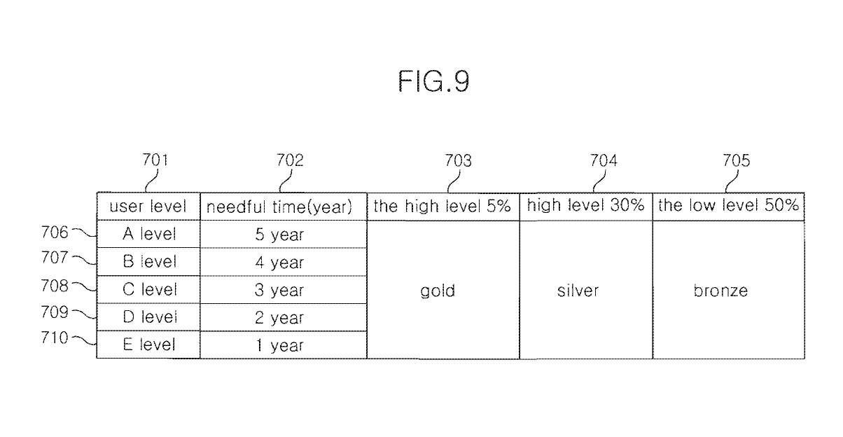

FIG. 8 is a diagram showing the movement process between the system server and the user's terminal, for usage of electronic teaching material file of the present invention. As illustrated in FIG. 8, user of electronic teaching material file can use user's terminal (603, 605) or bar code identifier when using books to search electronic teaching material contents.

When searching electronic teaching materials on the web page, wire and wireless user's terminal perform search by connecting to the web server. When searching by inputting search word sentence structures, if the user inputs content intended for search, the system server (602) searches possessed identification codes and extracts data related to the corresponding content. Then, the system server presents the corresponding list with information such as electronic teaching material levels and classification standards. In addition to performing searches by inputting search words consisted of whole words, inputting basic units such as phoneme, syllable, alphabet and busu is possible. In other words, input basic units (phoneme, syllable, alphabet, and busu) of contents that is being searched. For example, as seen in FIG. 3, when searching contents of the sentence structure (204) [symbol] [symbol] [symbol] [symbol] [symbol] [symbol] (rest omitted) . . . ”, input basic units [symbol] [symbol] [symbol] [symbol] (rest omitted). Also, if the electronic teaching material user already acknowledges the identification code of corresponding sentence structure, the user can obtain corresponding information by directly inputting identification code “9.9.1.14.8.1.1.9.12 (rest omitted) . . . ” Once the basic unit and identification code is inputted, the system server (602) extracts matching data among the possessed identification codes, and presents the corresponding list with information such as the electronic teaching material level and classification standard. Then, when the wanted electronic teaching material is selected from the presented corresponding list, the identification code of the selected electronic teaching material is transmitted to the web server (601), and the system server (602) transmits related information to user's terminal (603, 605).

When using a book, search for related information on the book's upper portion sentence structure can be done using the bar code and identification code. When searching related information on electronic teaching materials using recognition of bar code (604), the corresponding information is transmitted via web after recognizing the bar code, printed on the upper portion of the sentence structure during usage of book, with a terminal (605). Likewise, when searching by directly inputting the identification code, the corresponding identification code inputted via user's terminal is transmitted to the web server (601) using the same method as above, and the system server (602) receives related information.

As seen above, the electronic teaching material contents data search system of the present invention allows users to search electronic teaching material via wire and wireless terminal and bar code identification terminal. Electronic teaching materials are stored in the database in the form of multimedia files. It is provided to the user via webpage, and can be printed or published in the form of books.

When stored in the form of multimedia files, search on user's terminal can be done using the combination of identification code and text data of selected sentence structure, which is stored in metadata of the header part. Thus, after inputting the search word sentence structure on user's terminal, corresponding data can be received by selecting the electronic teaching material among search results.

When printed in the form of a book, the bar code (or identification code) is also printed on the upper portion of selected sentence structure. This can be searched on user's terminal which can recognize bar codes. Thus, when using a book, related information can be received by recognizing the bar code on upper portion of the sentence structure using a terminal.

FIG. 9 is a diagram of the present invention showing standards applied when deciding levels of users who are registering and using electronic teaching material contents. As illustrated in FIG. 9, each user's level (701) is consisted of five levels, level A (706), level B (707), level C (708), level D (709), and level E (710). The amount of time (702) needed to attain each level (706˜710) is 5 years for level A, 4 years for level B, 3 years for level C, 2 years for level D and 1 year for level E. The point units existing are YEAR, MONTH, WEEK, DAY and HOUR, HOUR being the least point unit. 1 YEAR is 12 times 1 MONTH, 1 MONTH is 4 times 1 WEEK, 1 WEEK is 7 times 1 DAY and 1 DAY is 24 times 1 HOUR.

The top 5% (703), 30% (704), 50% (705) users are granted levels Gold, Silver and Bronze respectively.

Level A users can organize a community. In the community, a variety of point (mileage) trade such as individual guidance, group education and mentoring is possible. Merger, acquisition and division among communities are possible.

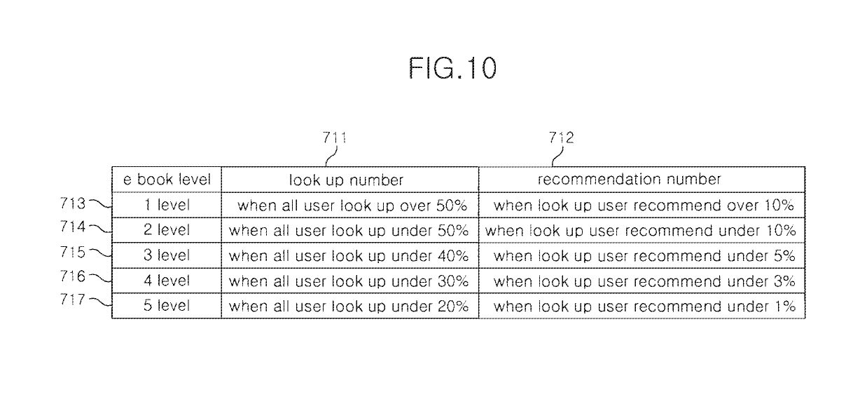

FIG. 10 is a diagram of the present invention showing standards applied when deciding levels of electronic teaching material contents based on user's number of inquiry and recommendation. As illustrated in FIG. 10, each electronic teaching material is classified into level 1 (713), level 2 (714), level 3 (715), level 4 (716) and level 5 (717) according to respective number of inquiry (711) and recommendation (712). If the number of inquiry and recommendation satisfies the requirements of corresponding level, the level of electronic teaching material is decided. For example, as in FIG. 10, if 50% of all users inquire, and 10% of those users recommend, the corresponding electronic teaching material content's level becomes level 1 (713).

FIG. 11 is a diagram of the present invention showing standards of granting trade points according to user's individual work. To vitalize provision of electronic teaching material contents, a standard of granting points according to individual activities is decided. According to the set of standards, upon registering electronic teaching materials, the electronic teaching material provider receives 5 HOUR points regardless of user level, and the user of this electronic teaching material is deducted 1 HOUR point regardless of user level.

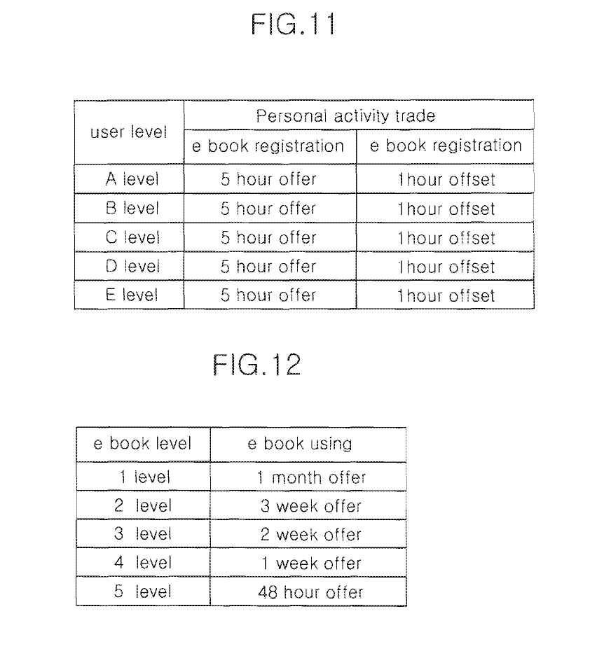

FIG. 12 is a diagram of the present invention showing standards of granting trade points according to electronic teaching material level. After an electronic teaching material is registered, and other users use this electronic teaching material, the level of this electronic teaching material is decided based on the number of inquiry and recommendation generated from usage. Once the level of electronic teaching material is decided, extra points are granted to the creator of corresponding electronic teaching material. The point granted at this time is vary in accordance to level of electronic teaching material. For example, as in FIG. 10, for electronic teaching material with number of inquiry more than 40% and less than 50% (711) of all users, and if more than 5% and less than 10% (712) of those users recommend the electronic teaching material, the electronic teaching material is granted level 2 (714). Also, the creator who provided corresponding electronic teaching material is granted 3 WEEK of points.

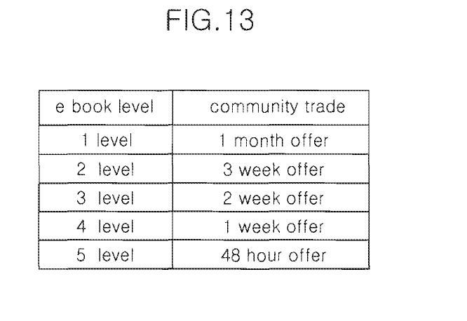

FIG. 13 is an explanation diagram of the present invention showing standards of granting points for internal trades in an electronic teaching material community. If a registered electronic teaching material is provided to a community, extra points are granted to the creator of that electronic teaching material. For example, if a level 2 electronic teaching material is provided to a specific community, an extra 3 WEEK point is granted to the creator of that electronic teaching material.

As seen above, the point management system of the present invention manages level of users and electronic teaching material according to usage of electronic teaching material corresponding to decided standards. This aims to vitalize provision of electronic teaching material, and provide reliable information related to the corresponding contents which the user can use as reference.

As the implementation examples of the present invention, electronic teaching material contents and users are managed according to levels, and higher levels receive privileges through provision of points. The creator receives points (5 HOUR) by creating and providing electronic teaching material, and the user of that electronic teaching material is deducted points (1 HOUR) for usage of electronic teaching material. Although the level of electronic teaching material is lowest level (level 5) upon registration, if electronic teaching material users frequently use and recommend the corresponding electronic teaching material, the number of inquiry and recommendation will accumulate eventually raising the level. Also, extra points are granted to the creator of electronic teaching material following rise of electronic teaching material's level and provision to the community. At this time, more points are granted if the level of electronic teaching material is higher.

Using the same method as above, management of trade and circulation of electronic teaching material is done by managing users and electronic teaching materials, inside the point management system, according to levels. Additionally, when the output part of above search results outputs search results through the user's sentence structure input and bar code recognition, level of electronic teaching material and electronic teaching material creator are also indicated, or the list of search is provided according to ranking of electronic teaching material's level.

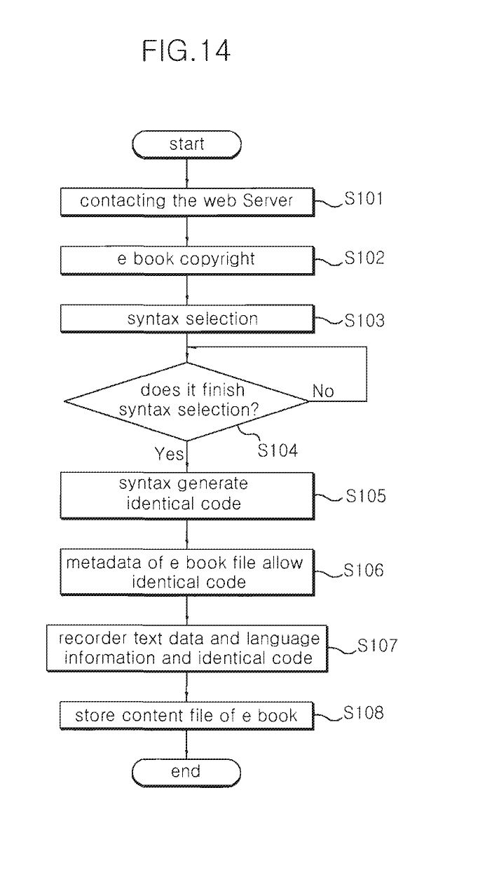

FIG. 14 is a flow chart of the present invention showing the method of granting identification code to sentence structure of electronic teaching material. As illustrated in FIG. 14, the method of granting identification code to sentence structure of electronic teaching material is as follows.

First, the electronic teaching material creation part connects to the web server (S101) and creates electronic teaching material using electronic teaching material contents (S102).

Then, the sentence structure selection part selects the sentence structure in the electronic teaching material contents file when registering the electronic teaching material on the web server (S103).

Then, the identification code production part decides if sentence structure selection is finished (S104), and if sentence structure selection is finished, peculiar identification code of the selected sentence structure is produced (S105).

Then, the identification code grant part grants the identification code to the metadata of file, which stores the electronic teaching material (S106).

Then, the metadata record part records text data, language information data of corresponding text data and identification code granted to the combination of these two on the metadata of electronic teaching material contents file (S107).

Then, the storage part stores electronic teaching material contents file recorded on metadata in the database. In other words, the electronic teaching material file is sent from the creator's terminal to the system server via web, and stored in the data base (S108).

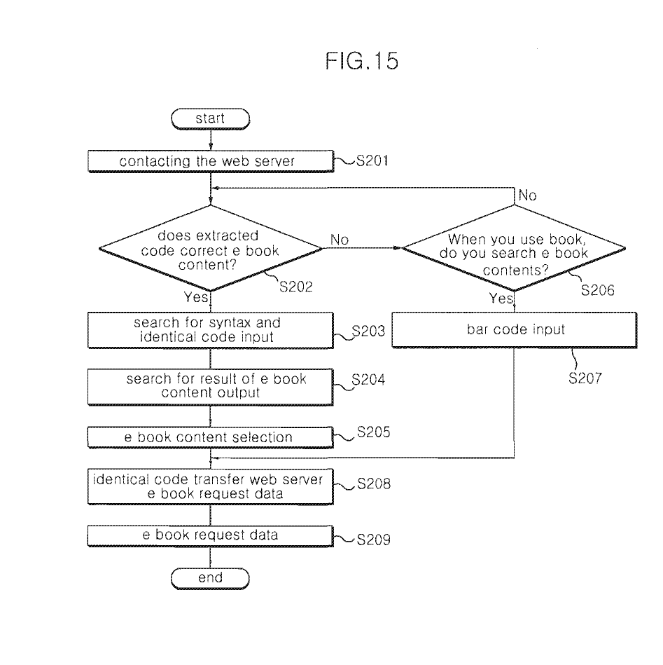

FIG. 15 is a flow chart of the present invention showing the data search method of electronic teaching material contents. As illustrated in FIG. 15, the data search method of electronic teaching material contents is as follows.

First, the identification code extraction part receives request from user's terminal to search electronic teaching material contents data for the peculiar identification code, connects to the web server (S201), and extracts corresponding identification code from corresponding electronic teaching material contents.

Then, the data request part transmits the identification code, corresponding to the data of electronic teaching material contents, extracted from the identification code extraction part, and requests the data of electronic teaching material contents matching the identification code of above (S208). Scrutinizing this process, after concluding whether the identification code corresponding to the electronic teaching material contents is extracted (S202), and if the identification code corresponding to the electronic teaching material contents on the web server is extracted, the search word sentence structure input part inputs search word sentence structure and identification code (S203). Then, search result output part outputs data search result of extracted electronic teaching material contents (S204), and contents selection part selects corresponding electronic teaching material contents from outputted electronic teaching material contents (S205). However, after concluding whether the identification code corresponding to the electronic teaching material contents on the web server is extracted (S202), and if the identification code corresponding to the electronic teaching material contents on the web server is not extracted, conclude whether search of electronic teaching material contents during usage of books is executed (S206). If search of electronic teaching material contents is not executed even during usage of books, conclude again, whether search of electronic teaching material contents on the web server is executed (S202), if search of electronic teaching material contents during usage of books is executed, input bar code (S207).

Then, the data transmission part receives data of electronic teaching material contents requested by the data request part above, and transmits it to the user's terminal (S209).

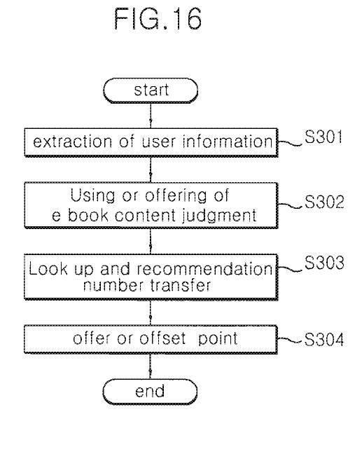

FIG. 16 is a flow chart of the present invention showing the point management method related to usage and provision of electronic teaching material contents. As illustrated in FIG. 16, point management method related to usage and provision of electronic teaching material contents is as follow.

First, the user information extraction part extracts user information from the storage (S301).

Then, the contents management part concludes whether to use the electronic teaching material contents on the user's terminal, or provide it to other user's terminal (S302).

Then, the transmission part, when usage of electronic teaching material or provision to others, transmits to the storage the number of inquiry and recommendation of user's terminal related to data of the electronic teaching material contents (S303).

Then, the point management part decides level of electronic teaching material based on number of inquiry and recommendation, and according to usage or provision of corresponding electronic teaching material, points are granted or deducted from the user's terminal, who provided the electronic teaching material above (S304).

As seen above, although, the technological concept behind method and system of granting identification code to sentence structure of electronic teaching material contents, data search system and method of electronic teaching material contents, and point management system and method related to usage and provision of electronic teaching material contents are described with the attached diagrams, this only explains the most exemplary execution example of the present invention, not limit the present invention. Also, to a person who possesses common knowledge of this technology field, it is clear that various modification and imitation is possible without breaking away from the technological concept of the present invention.

What is claimed is:

1. A system which grants identification code to sentence structure of electronic teaching material contents, the system includes:
an identification code production unit which distinguishes each syllable according to the language of selected sentence structure of the electronic teaching material contents, and produces peculiar identification code using first phoneme or syllable of each syllable; and
an identification code grant unit which grants identification code to metadata of file which stores the electronic teaching material contents.

2. The system according to claim 1, wherein the metadata include text data, language information data of corresponding text data and identification code granted to the combination of these data.

3. The system according to claim 1, wherein the identification code production unit produces the identification code of arbitrary byte by arranging basic units of language in order, assigning number code to each basic unit in order, extracting the first phoneme or syllable of each unit for a arbitrary number of units among the break units constituting the sentence structure, and combining the number codes corresponding to the first phoneme or syllable of each unit.

4. The system according to claim 3, wherein said number codes are assigned as decimal numbers expressible in 8 bits.

5. A method of granting identification code to sentence structure of electronic teaching material contents, the method includes:
allowing an identification code production unit to distinguish each syllable in selected sentence structure of electronic teaching material contents according to language types, and to produce peculiar identification code using the first phoneme or syllable of each syllable; and
allowing an identification code grant unit to grant identification code to metadata of file which stores the electronic teaching material contents.

6. A data search system of electronic teaching material contents, the data search system includes:
an identification code extraction unit which receives request to search electronic teaching material contents data which has peculiar identification code, and extracts corresponding identification code from the electronic teaching material contents;
a data request unit which transmits the identification code of electronic teaching material contents extracted from said identification code extraction unit to the web server, and requests data of the electronic teaching material contents matching the identification code; and
a data transmission unit which receives data of the electronic teaching material contents requested by the data request unit to the web server, and transmits it to the user's terminal.

7. The data search system according to claim 6, said identification code extraction unit includes:
a search word sentence structure input unit which inputs search word sentence structure and corresponding identification code when the identification code corresponding to data of electronic teaching material contents is extracted;
a search result output unit which outputs data search results of extracted electronic teaching material contents; and
a contents selection unit which selects corresponding electronic teaching material contents from the electronic teaching material contents.

8. A method of searching data for electronic teaching material contents, the method includes:
first step of allowing an identification code extraction unit to receive request from user's terminal to search electronic teaching material contents which have peculiar identification code, and to extract identification code corresponding to the electronic teaching material;
second step of allowing a data request unit to transmits the identification code of electronic teaching material contents data extracted from identification code extraction unit to the web server, and to requests data of electronic teaching material contents matching the identification code; and
third step of allowing a data transmission unit to receive the data of electronic teaching material contents requested by the data request unit, and to transmit it to the user's terminal.

9. The method of searching data for electronic teaching material according to claim 8, wherein said first step includes:
allowing a search word sentence structure input unit to input search word sentence structure and identification code, when the identification code corresponding to electronic teaching material contents is extracted;
allowing a search result output unit to output data search results of the extracted electronic teaching material contents; and
allowing a contents selection unit to select corresponding electronic teaching material contents from the extracted electronic teaching material contents.

10. The method of searching data for electronic teaching material according to claim 8, wherein said first step includes:
allowing a bar code input unit to conclude whether the data of electronic teaching material contents is searched during usage of books, if the data of electronic teaching material contents is not found on a webpage.

11. A point management system, related to usage and provision of electronic teaching material contents, the point management system includes:
a user information extraction unit which receives, from a user's terminal, a signal of using the electronic teaching material contents by the user's terminal or providing the electronic teaching material contents to other user's terminal by the user's terminal, and extracts user information corresponding to the user's terminal from a storage unit;
a contents management unit which determines whether to use the electronic teaching material contents or to provide the electronic teaching material contents to other user's terminal on the user's terminal corresponding to the extracted user information;
a transmission unit which transmits number of inquiry and recommendation of user's terminal, related to data of electronic teaching material contents during usage or provision of electronic teaching material contents to the storage unit; and
a point management unit which decides levels of electronic teaching material based on number of inquiry and recommendation, and according to usage or provision of corresponding electronic teaching material, grants or deducts point from the user's terminal which provided the electronic teaching material.

12. A point management method related to usage and provision of electronic teaching material contents, the point management method includes:
allowing a user information extraction unit to receive signal from user's terminal whether to use the electronic teaching material content on the user's terminal or to provide the electronic teaching material contents to other user's terminal, and to extract a user information of corresponding user's terminal from a storage unit;
allowing a contents management unit to determine whether to use the electronic teaching material contents on user's terminal corresponding to the extracted user information, or to provide the electronic teaching material contents to other user's terminal;
allowing a transmission unit, when using the electronic teaching material or providing the electronic teaching material to another person, to transmit number of inquiry and recommendation of user's terminal related to the data of electronic teaching material contents to the storage unit; and
allowing a point management unit to decides level of electronic teaching material based on the number of inquiry and recommendation, and according to usage or provision of corresponding electronic teaching material, to grant or deduct points from user's terminal which provided electronic teaching material.
